(19) United States
(12) Patent Application Publication
(10) Pub. No.: US 2004/0250407 A1
(43) Pub. Date: Dec. 16, 2004

(54) Device comprising components vertically stacked thereon and method for manufacturing the same

(75) Inventors: Jae Il You, Suwon (KR); Jong Tae Kim, Suwon (KR)

Correspondence Address: LOWE HAUPTMAN GILMAN & BERNER, LLP, Suite 300, 1700 Diagonal Road, Alexandria, VA, 22314, US

(73) Assignee: Samsung Electro-Mechanics Co., Ltd.

(21) Appl. No.: 10/888,934

(22) Filed: Jul. 12, 2004

Related U.S. Application Data
(62) Division of application No. 10/178,240, filed on Jun. 25, 2002.

(30) Foreign Application Priority Data
May 2, 2002 (KR) 2002-24153

(51) Int. Cl. H01G 7/00

(52) U.S. Cl. 29/592.1; 29/25.42

(57) ABSTRACT

Disclosed are a device, in which a plurality of components are vertically stacked on a substrate without any cavity being formed thereon, and a method for manufacturing the device, thereby easily manufacturing the device, improving the productivity of the device, and reducing the production cost of the device. The device of the present invention is manufactured by mounting a plurality of first components on a base substrate and forming supporters on the upper surface of the base substrate so that two or more of the supporters are arranged around each of the first components, molding the upper surface of the base substrate including the first components and the supporters, dicing the molded base substrate into device units, and mounting a second component on each of the upper surfaces of the diced parts of the base substrate.

### BACKGROUND OF THE INVENTION

1. Field of the Invention

The present invention relates to a device, in which components are stacked, and more particularly to a device, in which a plurality of components are vertically stacked on a substrate without any cavity formed thereon, and a method for manufacturing the device, thereby easily manufacturing the device, improving the productivity of the device, and reducing the production cost of the device.

2. Description of the Related Art

Recently, all electronic products progress toward miniaturization and light weight. In order to satisfy these recent trends, devices or components, which are employed by the electronic products, have also been developed toward miniaturization and light weight.

However, the development of the miniaturized components requires quite a long time. Therefore, it is necessary to develop a technique for manufacturing a miniaturized device using conventional components.

In order to miniaturize a device by assembling conventional components, a method of vertically stacking the components has been introduced.

A digital temperature compensated crystal oscillator is an example of a device manufactured by the aforementioned method. This digital temperature compensated crystal oscillator is manufactured by mounting an IC within a cavity of a substrate of an external package and by stacking crystal oscillating unit containing a crystal vibrating chip.

FIG. 1 is a transverse cross-sectional view of a conventional device, in which components are vertically stacked. This conventional device is manufactured by mounting a first component 12 within a cavity in a designated shape formed on a substrate 11 and by mounting a second component 14 on the upper surface of the substrate 11.

Herein, after the first component 12 is bonded on the cavity of the base substrate 11, the exposed surfaces of the first component must be molded. Therefore, after mounting the first component 12 within the cavity of the substrate 11, the cavity of the substrate 11 including the mounted first component 12 is molded with a resin.

FIGS. 2a through 2e are perspective views illustrating a method of manufacturing the conventional device, in which components are vertically stacked. As shown in FIG. 2a, a base substrate 11a is prepared. Then, as shown in FIG. 2b, a plurality of dielectric sheets 11b are laminated on the upper surface of the base substrate 11a, thereby forming a substrate 11. An opening for forming a cavity of the substrate 11 for mounting a first component (12 in FIG. 2c) is formed on the center of each of the dielectric sheets 11b.

As shown in FIG. 2c, the first component 12 is mounted within the cavity of the substrate 11, which is formed by laminating the dielectric sheets 11b on the base substrate 11a. Then, as shown in FIG. 2d, the cavity including the mounted first component 12 is molded, thereby forming a molding part. As shown in FIG. 2c, the second component 14 is mounted on the upper surface of the molding part by soldering.

For example, in the aforementioned digital temperature compensated oscillator, the second component 14 is a crystal oscillator unit with a largest size and the first component 12 is a digital component, that is, an IC for performing the digital temperature compensation.

In order to mount the first component 12 within the cavity of the substrate 11, at least three dielectric sheets 11a must be laminated. Further, the dimension of the cavity of the substrate 11 must be a little larger than that of the first component 12. As shown in FIG. 1, the side surface of the first component 12 must be separated from the inner wall of the cavity of the substrate 11 by a distance A. For example, A is 100 μm or more.

That is, in the method of manufacturing the conventional device, in which components are vertically stacked, a cavity must be formed on the substrate. Further, it is difficult to print patterns on the cavity of the substrate, thereby complicating the manufacturing process. Moreover, in order to mount the component on the cavity of the substrate, the dimension of the cavity of the substrate must be a little larger than that of the first component to be mounted within the cavity of the substrate, thereby imposing a limit in miniaturizing the substrate.

As shown in FIGS. 2a through 2e, the substrate is formed by laminating a plurality of the dielectric sheets, thereby increasing the production cost. Furthermore, since molding step is conducted on each device units separately after dicing the laminated sheets into each device units, the manufacturing process becomes complicated.

### SUMMARY OF THE INVENTION

Therefore, the present invention has been made in view of the above problems, and it is an object of the present invention to provide a device, in which a plurality of components are vertically stacked on a substrate without any cavity formed thereon, and a method for manufacturing the device, thereby easily manufacturing the device, improving the productivity of the device, and reducing the production cost of the device.

It is another object of the present invention to provide a miniaturized device comprising a plurality of components vertically stacked on a substrate, and a method for manufacturing the device, in which prior to dicing the substrate including plural components into device units, all the devices on the substrate are simultaneously and collectively molded, thereby simplifying the manufacturing process of the device.

In accordance with one aspect of the present invention, the above and other objects can be accomplished by the provision of a method of manufacturing a device, in which components are vertically stacked, comprising the steps of preparing a base substrate, mounting a plurality of first components on the base substrate and forming supporters on the upper surface of the base substrate so that two or more of the supporters are arranged around each of the first components, molding the upper surface of the base substrate including the first components and the supporters, dicing the molded base substrate into device units, and mounting a second component on each of the upper surfaces of the diced parts of the base substrate.

Preferably, the supporter may be higher than the first component.

Further, preferably, in the molding step, the upper surface of the base substrate including the first components and the supporters may be molded so that the upper surface of the molding should be higher than those of the first components and lower than those of the supporters. In another way, after molding the base substrate covering up all the supporters and the first component, the molded upper surface can be ground until the upper surfaces of the supporters are exposed prior to dicing the base substrate.

In accordance with another aspect of the present invention, there is provided a device, in which components are vertically stacked, comprising a base substrate, a first component mounted on the center of the upper surface of the base substrate, two or more supporters formed on the upper surface of the base substrate around the first component, a molding part entirely covering up the first components and exposing the upper surfaces of the supporters, and a second component attached to the upper surfaces of the supporters.

Preferably, the supporter may be higher than the first component.

Further, the molding part may be higher than the first component and lower than the supporters, or alternatively the molding part may be formed so that the upper surfaces of the supporters are exposed by grinding the upper surface of the molding part after entirely molding all the supporters and the first components.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a transverse cross-sectional view of a conventional device, in which a plurality of components are vertically stacked;

FIGS. 2a through 2e are perspective views illustrating a method of manufacturing the conventional device, in which a plurality of components are vertically stacked;

FIGS. 3a, 3b, and 3c are a transverse cross-sectional view, a longitudinal cross-sectional view, and a top view of a device, in which a plurality of components are vertically stacked, in accordance with the present invention, respectively;

FIGS. 4a through 4d are views illustrating a method of manufacturing a device, in which a plurality of components are vertically stacked, in accordance with a first embodiment of the present invention;

FIGS. 5a through 5e are views illustrating a method of manufacturing a device, in which a plurality of components are vertically stacked, in accordance with a second embodiment of the present invention; and

FIGS. 6a and 6b are schematic top views of the conventional device and the device of present invention, respectively.

### DESCRIPTION OF THE PREFERRED EMBODIMENTS

Hereinafter, preferred embodiments of the present invention will be described in detail with reference to the annexed drawings.

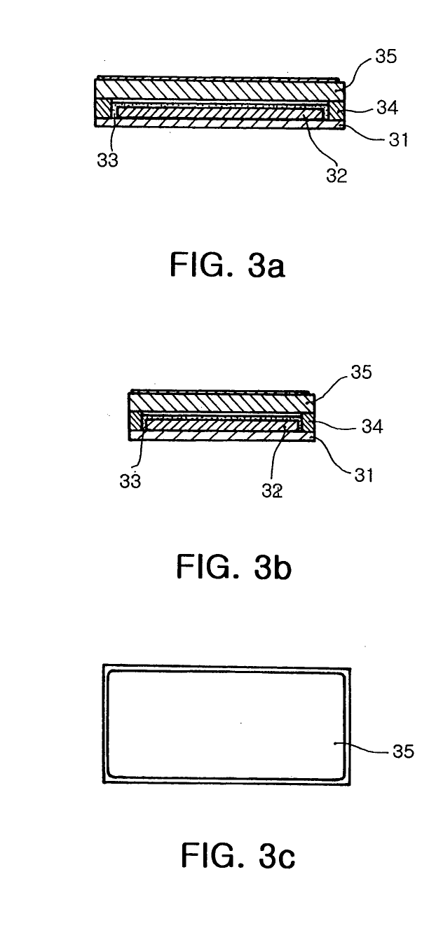

FIGS. 3a, 3b, and 3c are a transverse cross-sectional view, a longitudinal cross-sectional view, and a top view of a device, in which a plurality of components are vertically stacked, in accordance with the present invention, respectively.

As shown in FIGS. 3a through 3c, the device of the present invention comprises a base substrate 31, a first component 32 mounted on the center of the upper surface of the base substrate 31, a molding part 33 formed by molding the upper surface of the case substrate 31 including the first component 32, supporters 34 formed on the upper surface of the base substrate 31 around the first component 32, and a second component 35 mounted on the upper surfaces of the supporters 34.

Herein, the molding part 33 is formed on the base substrate 31 so that the upper surfaces of the supporters 34 are exposed from the molding part 33. That is, all parts formed on the upper surface of the base substrate 31 except for the upper surfaces of the supporters 34 are molded. The upper surfaces of the supporters 34 serve as parts on which the second component 35 is mounted by soldering.

The above-described device of the present invention does not require a cavity on the upper surface of the substrate. That is, the components are vertically mounted on the substrate without the cavity, thereby effectively utilizing the space.

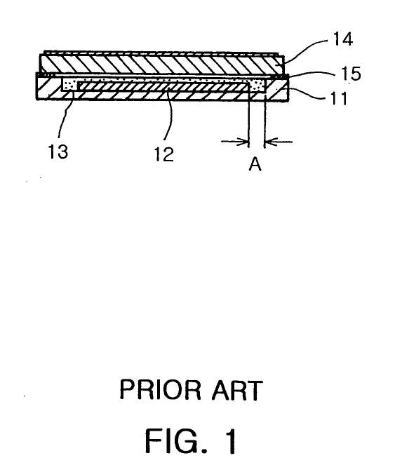

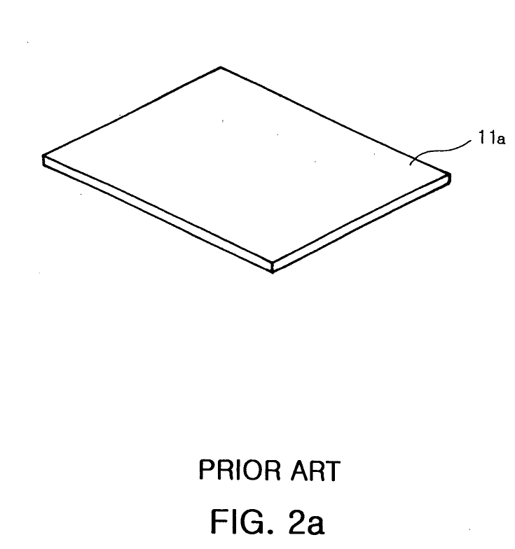

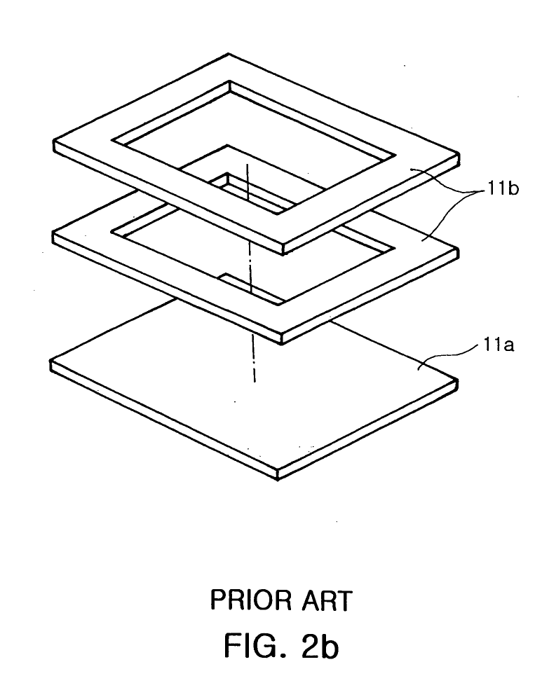

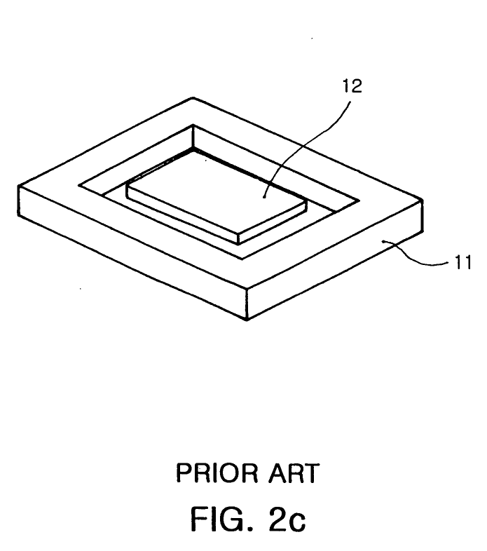

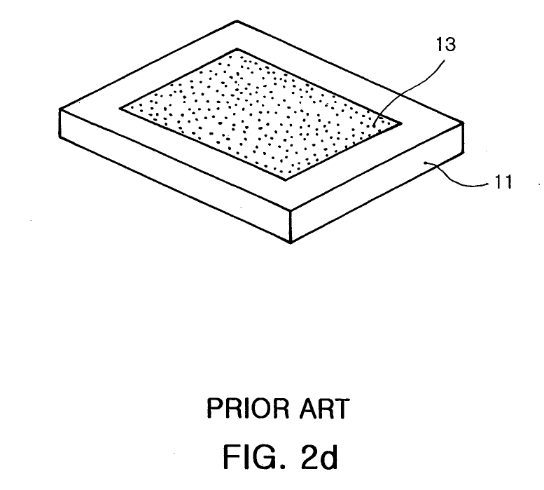

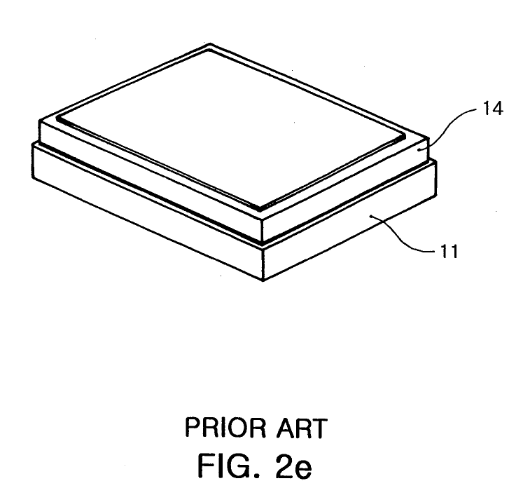

In the conventional device as shown in FIG. 1, in order to mold the cavity of the substrate 11 including the first component 12, the side surface of the mounted first component 12 must be separated from the inner wall of the cavity by a designated distance A.

However, in accordance with the present invention, plural supporters 34 are formed on the upper surface of the base substrate 11 around the mounted first component 32, and the second component 35 is mounted on the supporters 34, thereby minimizing the size of the package and miniaturizing the device. Further, in case that the size of the device of the present invention is the same as that of the conventional device, the size of the first component 22 can be increased, compared with that of the first component 12 of the conventional device.

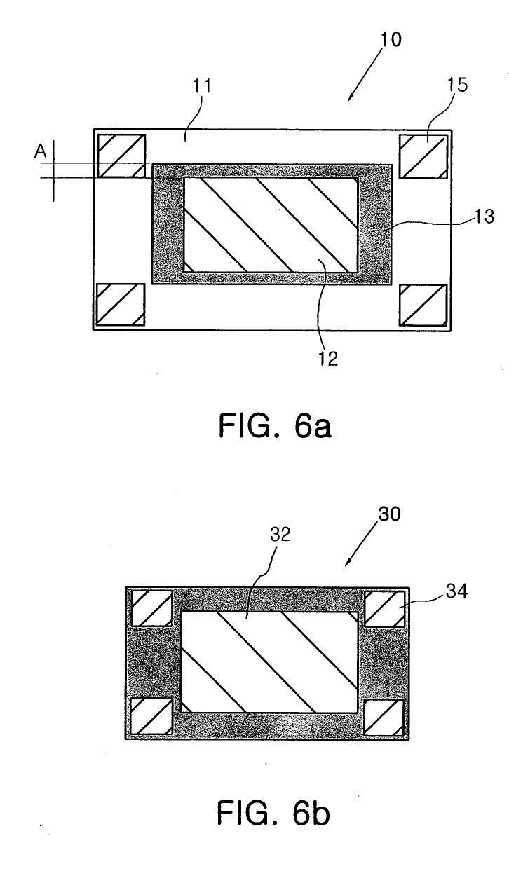

Hereinafter, with reference to FIGS. 6a and 6b, the conventional device and the device of the present invention are compared in detail. FIG. 6a shows the conventional device, in which the components are vertically stacked, and FIG. 6b shows the device, in which the components are vertically stacked, in accordance with the present invention. In case that the size of the first component 12 of the conventional device and the size of the first component 32 of the device of the present invention are the same, as shown in FIG. 6a, the conventional device requires a designated distance between the side surface of the first component 12 and the inner wall of the cavity of the substrate 11 for mounting the first component into the cavity and molding the cavity of the substrate 11 including the first component 12. Therefore, the cavity with a designated size larger than the size of the first component 12 by a distance A, and an external wall for forming the cavity impose a limit in miniaturizing the conventional device.

On the other hand, as shown in FIG. 6b, the device of the present invention comprises supporters 34 for supporting the second component 35 (FIG. 3). That is, the second component 35 (FIG. 3) is mounted on the supporters 34 without the cavity of the substrate 31 (FIG. 3). Therefore, compared with the conventional device of the FIG. 6a, the size of the device of the present invention can be remarkably miniaturized.

Therefore, the present invention reduces the size of the external package for mounting the components, thereby miniaturizing the device, in which the components are vertically stacked.

Further, even if the total size of the device of the present invention is the same as that of the conventional device, the present invention can use a low-priced integrated circuit (IC) chip with a larger size as the first component, thereby reducing the unit cost of production.

Moreover, in accordance with the following manufacturing method, the present invention simplifies the manufacturing process of the device, in which the components are vertically stacked and achieves the mass-production of the device, thereby improving the productivity of the device.

Hereinafter, a method of manufacturing the device, in which the components are vertically stacked, is described in detail.

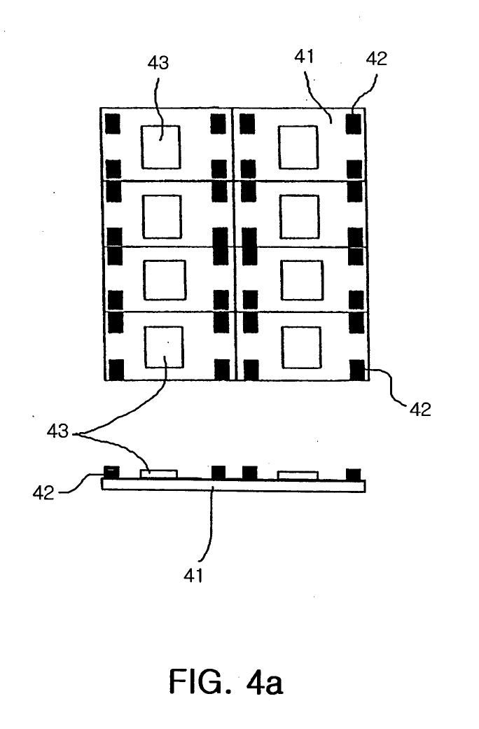

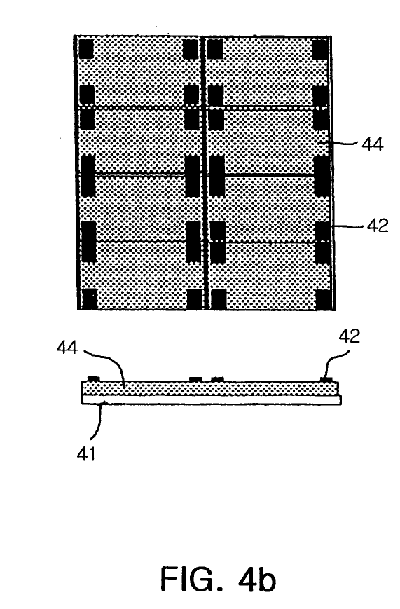

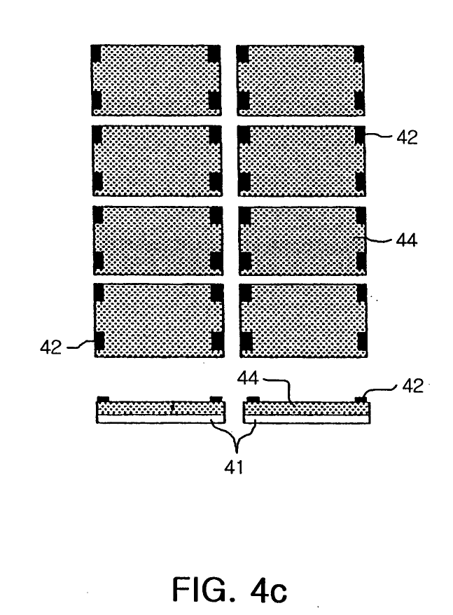

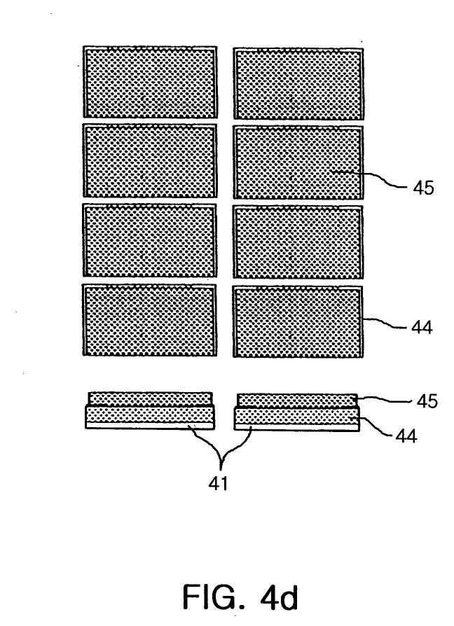

FIGS. 4a through 4d are views illustrating a method of manufacturing a device, in which a plurality of components are vertically stacked, in accordance with a first embodiment of the present invention.

As shown in FIG. 4a, a plurality of first components 43 are mounted on a base substrate 41. Plural supporters 42 are formed on the base substrate 41 around each of the mounted first components 43. Herein, each supporter 42 is formed on four corners around the mounted first component 43. FIG. 4a shows the first components 43 and the supporters 42 formed on the base substrate 41.

As shown in FIG. 4b, the base substrate 41 including the first components 43 and the supporters 42 is molded, thereby forming a molding part 44. Herein, the upper surfaces of the supporters 42 are exposed from the molding part 44. FIG. 4b shows the molding part 44 formed by molding the base substrate 41 including the first components 43 and the supporters 42.

Then, the base substrate 41 is diced into device units (each device unit including one first component 43 and four supporters 42 formed on four corners around the first component 43). FIG. 4c shows the base substrate 41, which is diced into device units.

As shown in FIG. 4d, a second component 45 is mounted on each of the resin molding parts 44 of the device units. The second component 45 is attached to the exposed upper surfaces of the supporters 42, thereby completing the manufacture of the device. FIG. 4d shows a plurality of the devices, in which the second components 45 are mounted on each of the diced parts of the base substrate 41.

In this method of the first embodiment of the present invention, it is rather difficult to mold the upper surface of the base substrate 41 including the first components 43 and the supporters 42 so that the upper surfaces of the supporters 42 are exposed from the molding part 44. If the upper surfaces of the supporters 42 are encapsulated by the molding part 44, the second component 45 cannot be stably mounted on the supporters 42.

Therefore, after entirely molding the first components 43 and the supporters 42, the upper surface of the molding part 44 may be ground so that the upper surfaces of the supporters 42 are exposed to the outside. Then, the second component 45 is attached to the exposed upper surfaces of the supporters 42 by soldering.

Herein, the height of the molding part 44 is minimized by the aforementioned grinding step, thereby reducing the total height of the device of the present invention.

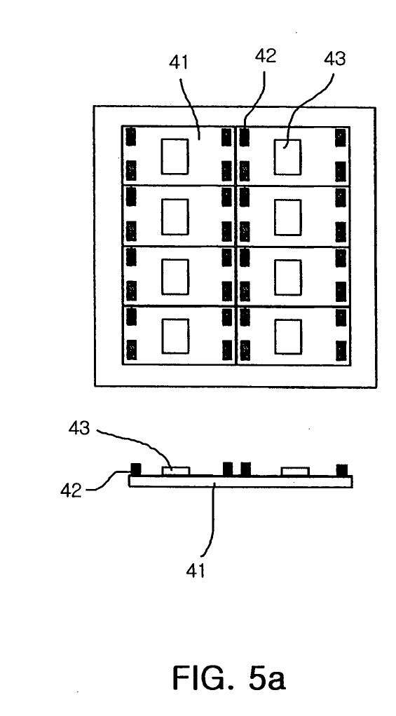

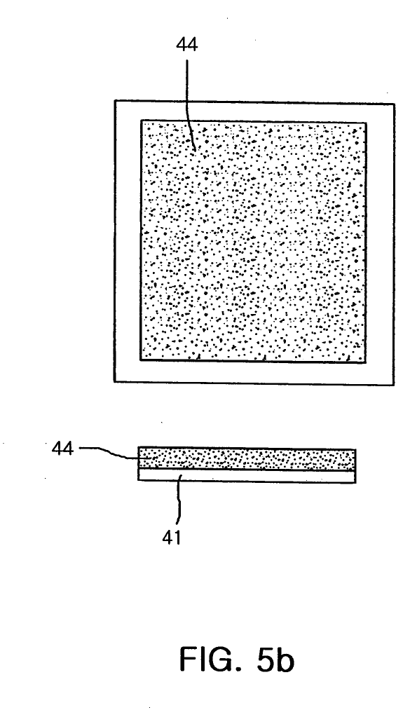

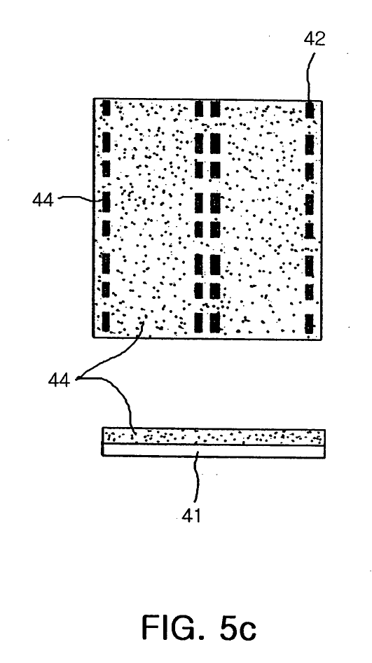

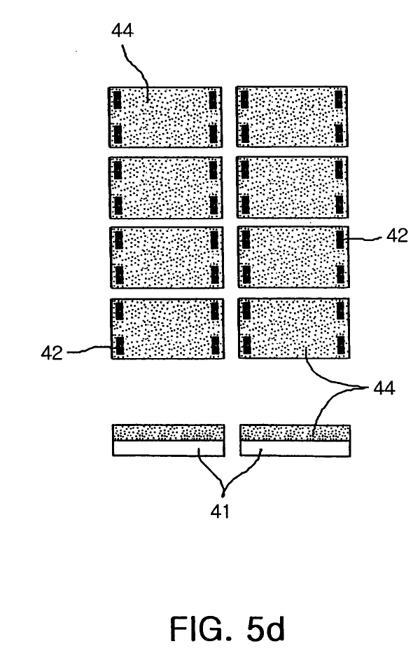

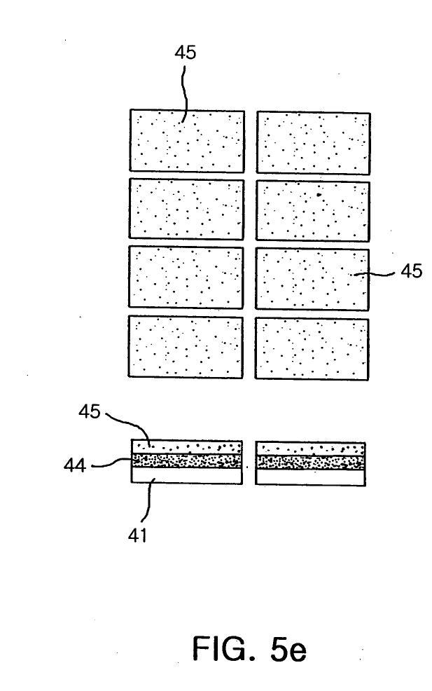

FIGS. 5a through 5e are views illustrating a method of manufacturing a device, in which a plurality of components are vertically stacked, in accordance with a second embodiment of the present invention. FIG. 5a shows a plurality of the first components 43 and the supporters 42 formed on the base substrate 41. FIG. 5b shows the molding part 44 formed by molding the base substrate 41 including the first components 43 and the supporters 42 so that the upper surfaces of the supporters 42 are entirely molded. FIG. 5c shows the result of grinding the upper surface of the molding part 44, thereby exposing the upper surfaces of the supporters 42 higher than the first components 43. FIG. 5d shows the ground base substrate 41, which is diced into device units. FIG. 5e shows a plurality of the devices, in which the second components 45 are mounted on each of the diced parts of the base substrate 41.

Herein, the second component 45 is attached to the exposed upper surfaces of the supporters 42 by soldering.

In this method of the second embodiment of the present invention, after entirely molding the first components 43 and the supporters 42, the upper surface of the molding part 44 is ground so that the upper surface of the ground molding part 44 is level with the exposed upper surfaces of the supporters 42, thereby easily performing the molding step and more stably attaching the second component 45 to the exposed upper surfaces of the supporters 42.

As apparent from the above description, in accordance with the present invention, the second component is mounted on the upper surface of the first component using the supporters without forming a cavity on the substrate. Therefore, the device of the present invention does not additionally require a step for forming the cavity on the substrate, thereby miniaturizing the device, in which the components are vertically stacked.

Further, even if the total size of the device of the present invention is the same as that of the conventional device, the present invention allows the device to mount larger components thereon. Therefore, in case using low-priced large integrated circuit (IC) chips as the components, the present invention reduces the unit cost of production of the device.

Moreover, in accordance with the present invention, it is possible to simultaneously and collectively mold a plurality of the components and the supporters formed on one substrate, thereby easily performing the molding step, simplifying the manufacturing process of the device, and improving the productivity of the device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-4. (Cancelled).

5. A device in which components are vertically stacked, said device comprising:
a base substrate;
a first component mounted on the center of the upper surface of the base substrate;
two or more supporters formed on the upper surface of the base substrate around the first component;
a molding part entirely molding the first component and exposing the upper surfaces of the supporters; and
a second component attached to the upper surfaces of the supporters.

6. The device in which components are vertically stacked according to claim 5, wherein the supporters are higher than the first component.

7. The device in which components are vertically stacked according to claim 5, wherein each supporter is formed on four corners of the base substrate around the first component.
